(19) United States
(12) Patent Application Publication
(10) Pub. No.: US 2010/0024433 A1
(43) Pub. Date: Feb. 4, 2010

(54) SYSTEM AND METHOD OF OPERATING A GAS TURBINE ENGINE WITH AN ALTERNATIVE WORKING FLUID

(76) Inventors: John Frederick Ackermann, Laramie, WY (US); Matthew Timothy Franer, Norwood, OH (US); Randy Lee Lewis, Lebanon, OH (US); David Allen Bell, Laramie, WY (US); Morris Dee Argyle, Laramie, WY (US); Brian Francis Towler, Laramie, WY (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(21) Appl. No.: 12/182,842

(22) Filed: Jul. 30, 2008

(51) Int. Cl. F02C 3/00; F02C 7/12

(52) U.S. Cl. 60/783; 60/39.5; 415/169.1

(57) ABSTRACT

A gas turbine engine system is provided. The gas turbine engine system includes a gas turbine engine, an exhaust gas conditioning system, and a sequestration chamber. The gas turbine engine includes at least one compressor, at least one combustion chamber downstream from the compressor, and at least one turbine downstream from the combustion chamber. The combustion chamber is coupled in flow communication to a source of hydrocarbonaceous fuel and to a source of oxygen. The gas turbine engine is operable with a working fluid that is substantially nitrogen-free. The exhaust gas conditioning system is coupled between a discharge outlet and an inlet of the gas turbine engine. The exhaust gas conditioning system receives all of the exhaust discharged from the gas turbine engine. The sequestration chamber stores carbon dioxide and is coupled to the gas turbine engine for receiving working fluid bled from the turbine upstream from combustion chamber.

### BACKGROUND OF THE INVENTION

The present disclosure relates generally to gas turbine engines and, more particularly, to gas turbine engine systems that operate with an alternative working fluid.

Gas turbine engines produce mechanical energy using a working fluid supplied to the engines. More specifically, in known gas turbine engines, the working fluid is air that is compressed and delivered, along with fuel and oxygen, to a combustor, wherein the fuel-air mixture is ignited. As the fuel-air mixture burns, its energy is released into the working fluid as heat. The temperature rise causes a corresponding increase in the pressure of the working fluid, and following combustion, the working fluid expands as it is discharged from the combustor downstream towards at least one turbine. As the working fluid flows past each turbine, the turbine is rotated and converts the heat energy to mechanical energy in the form of thrust or shaft power.

Air pollution concerns worldwide have led to stricter emissions standards both domestically and internationally. Pollutant emissions from at least some gas turbines are subject to Environmental Protection Agency (EPA) standards that regulate the emission of oxides of nitrogen (NOx), unburned hydrocarbons (HC), and carbon monoxide (CO). In general, engine emissions fall into two classes: those formed because of high flame temperatures (NOx), and those formed because of low flame temperatures that do not allow the fuel-air reaction to proceed to completion (HC & CO).

Air has been used as a working fluid because it is readily available, free, and has predictable compressibility, heat capacity, and reactivity (oxygen content) properties. However, because of the high percentage of nitrogen in air, during the combustion process, nitrogen oxide (NOx) may be formed. In addition, carbon contained in the fuel may combine with oxygen contained in the air to form carbon monoxide (CO) and/or carbon dioxide (CO₂).

To facilitate reducing NOx emissions, at least some known gas turbine engines operate with reduced combustion temperatures and/or Selective Catalytic Reduction (SCR) equipment. However, operating at reduced combustion temperatures reduces the overall efficiency of the gas turbine engine. Moreover, any benefits gained through using known SCR equipment may be outweighed by the cost of the equipment and/or the cost of disposing the NOx. Similarly, to facilitate reducing CO and/or CO₂ emissions, at least some known gas turbine engines channel turbine exhaust through a gas separation unit to separate CO₂ from nitrogen (N₂), the major component when using air as the working fluid, and at least one sequestration compressor. Again however, the benefits gained through the use of such equipment may be outweighed by the costs of the equipment.

### BRIEF DESCRIPTION OF THE INVENTION

In one aspect a method of operating a turbine engine system is provided. The method comprises supplying a flow of oxygen and a flow of hydrocarbonaceous fuel to a combustion chamber defined within the turbine engine system, supplying a working fluid to an inlet of the turbine engine system, wherein the working fluid is substantially nitrogen-free, and bleeding a portion of the working fluid from the turbine engine system upstream from the combustion chamber, wherein the portion of the working fluid bled from the compressor is channeled to a sequestration storage chamber and wherein the and wherein the turbine engine system is operable with the resulting fuel-oxygen-working fluid mixture.

In another aspect a gas turbine engine system is provided. The gas turbine engine system includes a gas turbine engine, an exhaust gas conditioning system, and a sequestration chamber. The gas turbine engine includes at least one compressor, at least one combustion chamber downstream from the at least one compressor, and at least one turbine downstream from the at least one combustion chamber. The at least one combustion chamber is coupled in flow communication to a source of hydrocarbonaceous fuel and to a source of oxygen. The gas turbine engine operable with a working fluid that is substantially nitrogen-free. The exhaust gas conditioning system is coupled between a discharge outlet of the gas turbine engine and an inlet of the gas turbine engine. The exhaust gas conditioning system receives all of the exhaust discharged from the gas turbine engine. The sequestration chamber stores carbon dioxide and is coupled to the gas turbine engine for receiving working fluid bled from the turbine upstream from the at least one combustion chamber.

In a further aspect, an engine is provided. The engine includes an engine inlet, at least one compressor, at least one combustion chamber; and an engine outlet. The compressor is coupled in flow communication between the engine inlet and the at least one combustion chamber. The at least one combustion chamber is coupled to a source of hydrocarbonaceous fuel, to a source of oxygen. The inlet is coupled in flow communication to the turbine outlet for receiving a source of substantially nitrogen-free working fluid discharged from the outlet. The at least one combustion chamber is also coupled to a sequestration chamber for discharging for storage at least a portion of working fluid discharged from the at least one compressor.

### BRIEF DESCRIPTION OF THE DRAWINGS

FIG. 1 is a schematic illustration of an exemplary gas turbine engine.

FIG. 2 is a schematic illustration of an exemplary turbine engine system that may include the gas turbine engine shown in FIG. 1.

### DETAILED DESCRIPTION OF THE INVENTION

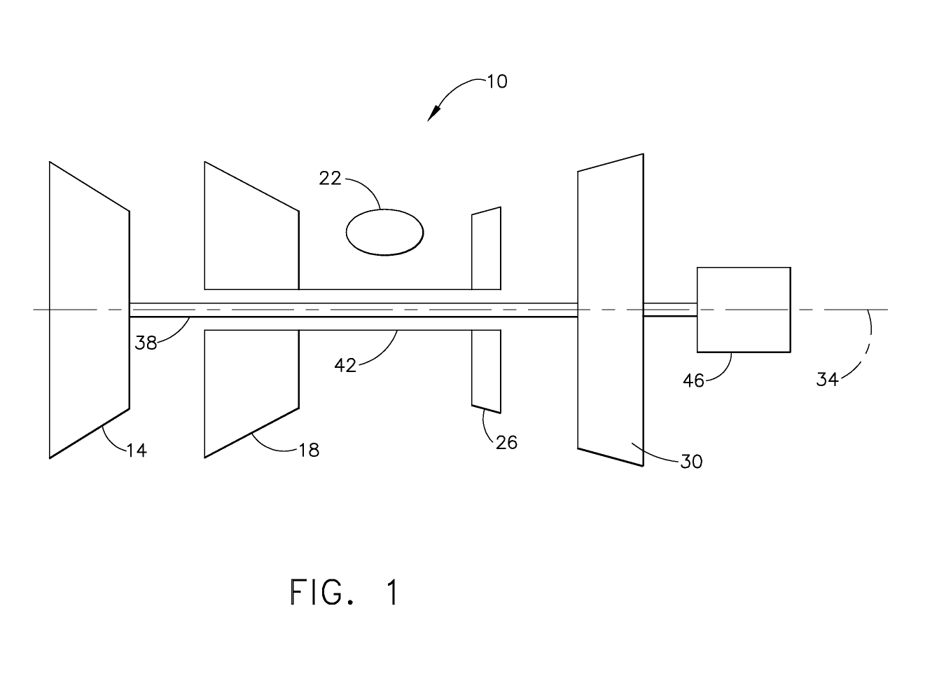

FIG. 1 is a schematic illustration of an exemplary gas turbine engine 10. In the exemplary embodiment, engine 10 includes a low pressure compressor 14, a high pressure compressor 18 downstream from low pressure compressor 14, a combustor assembly 22 downstream from high pressure compressor 18, a high pressure turbine 26 downstream from combustor assembly 22, and a low pressure turbine 30 downstream from high pressure turbine 26. Moreover, in the exemplary embodiment, compressors 14 and 18, combustor assembly 22, and turbines 26 and 30 are coupled together in a serial flow communication

In the exemplary embodiment, the rotatable components of gas turbine engine 10 rotate about a longitudinal axis indicated as 34. A typical configuration for engines of this type is a dual concentric shafting arrangement, wherein low pressure turbine 30 is drivingly coupled to low pressure compressor 14 by a first shaft 38, and high pressure turbine 26 is drivingly coupled to high pressure compressor 18 by a second shaft 42 that is internal to, and concentrically aligned with respect to, shaft 38. In the exemplary embodiment, low pressure turbine 30 is coupled directly to low pressure compressor 14 and to a load 46. For example, in one embodiment, engine 10 is manufactured by General Electric Company of Evendale, Ohio under the designation LM6000. Although the present invention is described as being utilized with gas turbine engine 10, it will be understood that it can also be utilized with marine and industrial gas turbine engines of other configurations, such as one including a separate power turbine downstream from low pressure turbine 30 that is connected to a load (e.g., an LM1600 manufactured by General Electric Company), or to a single compressor-turbine arrangement (e.g., the LM2500 manufactured by General Electric Company), as well as with aeronautical gas turbine engines and/or heavy duty gas turbine engines that have been modified appropriately.

During operation, air enters through an inlet and is channeled towards high pressure compressor 14 and then to low pressure compressor 18. Compressed air is delivered to combustor 22 wherein the air is at least mixed with fuel and ignited. Airflow discharged from combustor 18 drives high pressure turbine 26 and low pressure turbine 30 prior to exiting gas turbine engine 10.

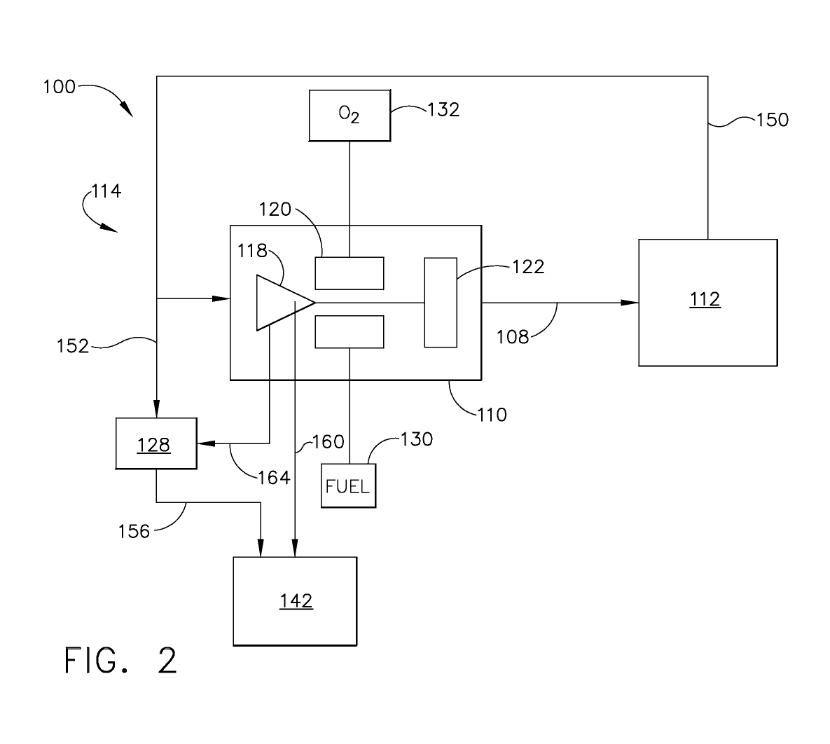

FIG. 2 is a schematic illustration of an exemplary turbine engine system 100 that may be used with gas turbine engine 10 (shown in FIG. 1). Alternatively, system 100 may be used with a land-based and/or aero-derived turbine, a single-or duel-fueled turbine, and/or any turbine that has been modified to enable system 100 to function as described herein. Moreover, system 100 may be used as a simple cycle machine, or may be used within a combined cycle system, including an integrated gasification combined cycle (IGCC) system.

In the exemplary embodiment, system 100 includes a turbine engine 110, a heat exchanger or an air separator unit (ASU) 112, and a sequestration sub-system 114. More specifically, in the exemplary embodiment, turbine engine 110 includes at least one compressor 118 and a combustion chamber 120 that are coupled upstream from at least one turbine 122. In the exemplary embodiment, compressor 118 is a multi-staged, over-sized, high-pressure compressor. In other embodiments, engine 110 may include other components, such as, but not limited to, a fan assembly (not shown), and/or a low pressure compressor. Moreover, in other embodiments, system 100 may include any exhaust gas conditioner, other than a heat exchanger or ASU, that enables system 100 to function as described herein.

Engine 110 is coupled in flow communication with a source of hydrocarbonaceous fuel 130 and to a source of oxygen 132. In the exemplary embodiment, fuel supplied from fuel source 130 may be, but is not limited to being, natural gas, syngas and/or distillates. In one embodiment, oxygen is supplied to engine 110 from a pressure-cycle, or other O₂ separator. In another embodiment, oxygen source 132 is a pressurized oxygen tank. Moreover, in another embodiment, the source of oxygen 132 is coupled to a pressurizing source (not shown), such as a compressor, to ensure that the supply of oxygen is supplied to engine 110 at a pre-determined operating pressure.

Heat exchanger or an air separator unit (ASU) 112 is coupled downstream from, and in flow communication with, turbine 110, such that all exhaust gases 108 discharged from turbine 110 are channeled through exchanger 112. In the exemplary embodiment, heat exchanger 112 facilitates removing heat and water vapor from exhaust gases 108 channeled therethrough. More specifically, in the exemplary embodiment, exchanger 112 is coupled in flow communication with a source of cooling fluid, such as, but not limited to air or water.

Heat exchanger 112 is also coupled upstream from, and in flow communication with, turbine 110, such that heat exchanger 112 supplies working fluid to turbine 110 during engine operations. Sequestration sub-system 114 is coupled in flow communication with, and downstream from, heat exchanger 112. More specifically, in the exemplary embodiment, sequestration sub-system includes an air cycle machine (ACM) 128 that is coupled downstream from heat exchanger 112 and a storage chamber or gas dome 142. In one embodiment, storage chamber 142 is a sub-surface sequestration chamber. In another embodiment, chamber 142 is a sub-surface geologic feature and/or a depleted natural gas dome.

Storage chamber 142 is coupled downstream from ACM 128 and downstream from a portion of turbine 110, as described in more detail below. In one embodiment, storage chamber 142 is a sub-surface sequestration chamber. More specifically, in the exemplary embodiment, as described in more detail below, heat exchanger 112 discharges a stream of CO₂ and steam, i.e., a working fluid stream 150, from turbine exhaust 108 to an inlet of turbine engine 110 for use in combustion chamber 120. In an alternative embodiment, system 100 does not include ACM 128.

To facilitate start up operations of turbine engine 110, in one embodiment, turbine engine 110 is also coupled to a source of pressurized CO₂. During operations, in the exemplary embodiment, CO₂ is supplied to an inlet (not shown) of turbine engine 110, and enters turbine engine 110 upstream from high pressure compressor 118. Moreover, engine 110 is also supplied with a flow of hydrocarbonaceous fuel from fuel source 130 and oxygen from oxygen source 132. In the exemplary embodiment, fuel source 130 and oxygen source 132 are each coupled to combustion chamber 120 and supply respective streams of fuel and oxygen directly to combustion chamber 120. The fuel and oxygen are mixed with compressed CO₂ stream 150 discharged from compressor 118, and the resulting mixture is ignited within combustion chamber 120. The resulting combustion gases produced are channeled downstream towards, and induce rotation of, turbine 122. Rotation of turbine 122 supplies power to load 46 (shown in FIG. 1). In the exemplary embodiment, all of the exhaust gases 108 discharged from turbine engine 110 are channeled through heat exchanger 1 12.

As such, during operation, turbine engine 110 is operated using a working fluid 150 that is substantially nitrogen-free. For example, in the exemplary embodiment, the working fluid 150 is between approximately 99% and 100% free from nitrogen. More specifically, and as described in more detail below, in the exemplary embodiment, working fluid stream 150 is substantially carbon dioxide CO₂. For example, in the exemplary embodiment, the working fluid 150 is between approximately 98% and 100% CO₂.

Because turbine engine 110 uses working fluid stream 150, and because stream 150 is substantially nitrogen-free, during engine operations, substantially little or no NOx is produced. As such, combustion chamber 120 can be operated at a higher temperature than known combustion chambers operating with air as a working fluid, while maintaining NOx emissions within pre-determined limits. The higher operating temperatures facilitate combustion chamber 120 operating closer to, or at, its thermodynamic optimum. Moreover, the use of a nitrogen-free working fluid 150, facilitates less costly production of power from turbine engine system 100 as compared to known turbine engine systems which use more expensive/less reliable nitrogen/carbon dioxide sequestration equipment.

In addition, because stream 150 is substantially nitrogen-free and only contains substantially carbon dioxide, during engine operations, turbine engine 110 is operable with a higher heat capacity. In some embodiments, the higher heat capacity facilitates the operation of turbine engine system 100 with higher compressor exit pressures at equivalent temperatures (i.e., more compressor stages at equal temperature) as compared to conventional turbine engine systems. As such, the overall operating efficiency of turbine engine system 100 is higher as compared to other known turbine engine systems. Moreover, with the use of working fluid 150, combustion rates within turbine engine system 100 are more easily controlled via control of the amount of oxygen supplied to turbine 110 as compared to the amount of carbon dioxide supplied to turbine 110, i.e., an O2/CO₂ ratio, as compared to known turbine engine systems. As such, a more uniform heat release and/or advanced re-heat combustion is facilitated to be achieved.

Moreover, during turbine operation, in the exemplary embodiment, cooling fluid flowing through heat exchanger 112 facilitates reducing an operating temperature of gases 108, such that water vapor contained in exhaust gases 108 is condensed and such that carbon dioxide CO₂ contained in exhaust gases 108 is substantially separated from the water vapor. In the exemplary embodiment, all of the residual CO₂ stream produced is returned to engine 110 via working fluid stream 150. Depending on loading requirements, a portion of CO₂, i.e., a sequestration stream 152, discharged from heat exchanger 112 within stream 150 is bled off and channeled through ACM 128, as described in more detail below.

As is known in the art, ACM 128 facilitates reducing the operating temperature and increasing the operating pressure of stream 152. The reduced operating temperature facilitates increasing a density of stream 152 which facilitates a stream 156 being discharged from ACM 128 to storage chamber 142 at a higher pressure than would normally be possible with than streams 152 having a higher operating temperature. The increased pressure facilitates the compression of stream 156 within storage chamber 142. In addition, in the exemplary embodiment, depending on loading requirements, a portion 160 of working fluid 150 entering turbine 110 is bled from compressor 118 for sequestration. More specifically, in the exemplary embodiment, the portion 160 of CO₂ stream 150 bled from compressor 118 is approximately equal to the volume (or mass) fraction of CO₂ produced during combustion. The higher heat capacity of the CO₂ working fluid stream 150 may be of a sufficient pressure to enable the portion 160 bled from compressor 118 to be channeled directly to storage chamber 142. Alternatively, if loading/storage requirements demand that higher pressures are necessary to facilitate optimal use of storage chamber 142, additional portions 164 of CO₂ stream 150 may be bled from compressor 118 and channeled to ACM 128 prior to CO₂ stream 156 being channeled to storage chamber 142.

The above-described method and system for operating a turbine engine system with a substantially nitrogen-free working fluid facilitate the production of power from a turbine engine in a cost-efficient and reliable manner. Further, the above-described method and system facilitates reducing the generation of nitrous oxide and carbon dioxide as compared to known turbine engines. As a result, a turbine engine system is provided that facilitates the generation of clean and relatively inexpensive power, while reducing the emission/generation of NOx, CO, and CO₂.

Exemplary embodiments of a method and system for operating a turbine engine with a substantially nitrogen-free working fluid are described above in detail. The method and systems are not limited to the specific embodiments described herein, but rather, steps of the method and/or components of the system may be utilized independently and separately from other steps and/or components described herein. Further, the described method steps and/or system components can also be defined in, or used in combination with, other methods and/or systems, and are not limited to practice with only the method and system as described herein.

When introducing elements of the present invention or preferred embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A method of operating a turbine engine system, said method comprising:
supplying a flow of oxygen and a flow of hydrocarbonaceous fuel to a combustion chamber defined within the turbine engine system;
supplying a working fluid to an inlet of the turbine engine system, wherein the working fluid is substantially nitrogen-free; and
bleeding a portion of the working fluid from the turbine engine system upstream from the combustion chamber, wherein the portion of the working fluid bled upstream from the combustion chamber is channeled to a sequestration storage chamber and wherein the turbine engine system is operable with the resulting fuel-oxygen-working fluid mixture.

2. A method in accordance with claim 1 further comprising:
igniting the fuel-oxygen-working fluid mixture in the combustion chamber; and
channeling all of the exhaust discharged from the combustion chamber to the inlet of the turbine engine system for use as the working fluid.

3. A method in accordance with claim 2 wherein channeling all of the exhaust discharged from the combustion chamber further comprises channeling all of the exhaust from the combustion chamber to an exhaust gas conditioning system coupled between a discharge outlet of the gas turbine engine and the inlet of the turbine engine system.

4. A method in accordance with claim 3 further comprising at least one of:
channeling a portion of exhaust discharged from the exhaust gas conditioning system to the sequestration storage chamber;
channeling a portion of exhaust discharged from the exhaust gas conditioning system to an air cycle machine coupled to the sequestration storage chamber; and
bleeding a portion of the working fluid from upstream of the combustion chamber to the air cycle machine.

5. A method in accordance with claim 4 further comprising channeling fluids discharged from the air cycle machine to the sequestration storage chamber.

6. A gas turbine engine system comprising:
a gas turbine engine comprising at least one compressor, at least one combustion chamber downstream from said at least one compressor, and at least one turbine downstream from said at least one combustion chamber, said at least one combustion chamber coupled in flow communication to a source of hydrocarbonaceous fuel and to a source of oxygen, said gas turbine engine operable with a working fluid that is substantially nitrogen-free;
an exhaust gas conditioning system coupled between a discharge outlet of said gas turbine engine and an inlet of said gas turbine engine, said exhaust gas conditioning system receives all of the exhaust discharged from said gas turbine engine; and
a sequestration chamber for storing carbon dioxide, said sequestration chamber coupled to said gas turbine engine for receiving working fluid bled from said turbine upstream from said at least one combustion chamber.

7. A gas turbine engine system in accordance with claim 6 further comprising an air cycle machine coupled to said exhaust gas conditioning system for receiving a portion of working fluid discharged from said exhaust gas conditioning system.

8. A gas turbine engine system in accordance with claim 6 further comprising an air cycle machine coupled to said gas turbine engine for receiving a portion of working fluid bled from said at least one compressor.

9. A gas turbine engine system in accordance with claim 8 wherein said air cycle machine is further coupled to said exhaust gas conditioning system for receiving a portion of working fluid discharged from exhaust gas conditioning system.

10. A gas turbine engine system in accordance with claim 8 wherein said sequestration chamber is coupled to said air cycle machine for receiving fluid flow discharged from said air cycle machine.

11. A gas turbine engine system in accordance with claim 6 wherein said sequestration chamber comprises a sub-surface storage chamber.

12. A gas turbine engine system in accordance with claim 6 wherein said exhaust gas conditioning system comprises at least one of a heat exchanger and an air separation unit coupled in flow communication between said gas turbine engine inlet and discharge outlet.

13. An engine comprising:
an engine inlet;
at least one compressor;
at least one combustion chamber; and
an engine outlet, said compressor coupled in flow communication between said engine inlet and said at least one combustion chamber, said at least one combustion chamber coupled to a source of hydrocarbonaceous fuel and to a source of oxygen, said inlet coupled in flow communication to said turbine outlet for receiving a source of substantially nitrogen-free working fluid discharged from said outlet, said at least one compressor further coupled to a sequestration chamber for discharging for storage at least a portion of working fluid discharged from said at least one compressor.

14. An engine in accordance with claim 13 further comprising an exhaust conditioning system coupled between said engine outlet and said engine inlet.

15. An engine in accordance with claim 14 wherein said exhaust conditioning system comprises at least one of a heat exchanger and an air separation unit.

16. An engine in accordance with claim 15 wherein said exhaust conditioning system is configured to remove at least one of water vapor and heat from working fluid discharged from said outlet.

17. An engine in accordance with claim 13 wherein said at least one compressor is further coupled to an air cycle machine that receives a portion of working fluid bled from said at least one compressor.

18. An engine in accordance with claim 13 wherein said exhaust conditioning system facilitates reducing nitrous oxide emissions generated from said engine.

19. An engine in accordance with claim 13 wherein said exhaust conditioning system facilitates improving gas turbine engine performance.
